(19) United States
(12) Patent Application Publication
(10) Pub. No.: US 2006/0115801 A1
(43) Pub. Date: Jun. 1, 2006

(54) Instruction follow up method

(76) Inventors: Christine Ganley, North Aurora, IL (US); Anna Maria C. Kirchner, Chicago, IL (US)

Correspondence Address: BARNES & THORNBURG, LLP, P.O. BOX 2786, CHICAGO, IL, 60690-2786, US

(21) Appl. No.: 11/001,168

(22) Filed: Dec. 1, 2004

(51) Int. Cl. G09B 19/00

(52) U.S. Cl. 434/219; 434/307 R

(57) ABSTRACT

The present invention provides a method of enhancing the retention of learning objective information imparted to a student during an event training program. The method includes performing assigned activities by the student following the event training, which activities include tasks putting into actual practice in the student's daily activities, objective information imparted to the student during the event training program, and participation by the student in one or more follow up conference sessions during which sessions the learning objective information imparted to the student during the event training is reinforced through predetermined discussion conducted by a follow up program facilitator. The preparation of content material for each follow up session is predicated upon and includes the original content of the event training, along with information gathered from each student prior to each follow up session, such information including the culmination of student experiences learning the content in performing the assigned activities. The discussion at the follow up conference includes comments from the student on experiences gained from actual practice of the tasks. The retention of learning objective information by a student after an event training program is evaluated, the evaluation including an assessment of assignments completed by the student and by the student's participation in the discussion.

### FIELD OF THE INVENTION

The present invention relates generally to educational training follow up methods, and in particular to a method of ensuring that educational and/or training information imparted to a student or trainee during one or more educational sessions is reasonably retained by the student/trainee subsequent to the educational sessions.

### BACKGROUND OF THE INVENTION

The most prevalent form of imparting information or knowledge, used both in schools and in the business world, has been the instructor-led style of classroom learning, lecture and individual task. In this environment, a teacher or trainer stands in front of the class and delivers instructional material to the students/trainees. The trainer may also utilize a variety of tools to ensure the educational point is mentally absorbed by the student(s). These tools include the use of books or other printed materials, images projected on a screen, software programs, lectures, questions and answers, role plays, interactive games, etc. Another training pedagogy that is gaining in popularity is the transmission of educational materials between a student or trainee and the instructor over the internet. These students and trainees, after viewing and/or listening to the course materials on their computer screen, may submit homework assignment responses online or by other known means, which responses are graded by the instructor. Exams are either given online or are proctored.

The intent of any of these educational and training vehicles has always been to have the trainees reach a predetermined competency level as a result of being present to receive the information. This form of training is identified as “event training,” since an educator or trainer must be present, either physically or by means of some technology such as audio, video or the internet, in order to conduct the session in a focused environment free of distraction. It is an “event” since participants are isolated from their normal routine, and the amount of education time is finite due to the fact that the trainer must be present to impart the information/knowledge to the student/trainee. In most corporate training applications, the event training can be as short as under an hour, or as long as several weeks in duration. Generally, once an idea is imparted to the student group, the next level of information, built upon the first ideas, is then imparted to the student or students. In most instances, once an idea is presented and explained, an assumption is created that the knowledge will be retained and the expected competency level achieved. This assumption, however, has proven to be false, substantially due to a lack of implementation support to transfer learning beyond the event training to the actual workplace. Prior educational and training programs, such as self directed learning or distance learning for example, are rarely incorporated as an extension or part of the event itself.

Studies have shown that if someone is exposed to an idea a mere one time, then only 2% of the information is retained 14 days later. However, if someone is exposed to an idea just six times in spaced intervals, then information retention improves to 62%. If the student is required to put the idea into actual practice, it can be expected that information retention is even higher.

Humans learn based on three styles of processing information: visual, auditory, and kinesthetic. Visual learners learn best when information is presented via printed materials, pictures, graphs, charts, or any means which stimulate the visual sense. Auditory learners learn best when information is presented through auditory means, such as hearing a lecture, listening to words, music or other sounds. Kinesthetic learners learn best when information is presented in such a way that physical sensation is evoked including touch, taste, smell, and emotions. While everyone will learn when information is imparted using all three techniques, there is generally a primary learning style individuals use making it easier to understand and retain concepts.

Most of the traditional training methodologies using lecture and reading activities speak to the immediate transfer of learning and do not address long term retention of information. Without some sort of interactive component during and after the event training, students/trainees are less likely to transfer learning from the classroom to the job. Practice exercises, role plays, games and the like during an event training are designed to address all learning styles. However, without proper auditory, visual and kinesthetic techniques to reinforce the information after event training, retention can be expected to be diminished.

Traditionally, learning objectives are established on three criteria: increase the body of knowledge, develop new and improved skills and enhance attitude. These three criteria create the objectives and also become the measuring tool to determine the effectiveness of the training. Moreover, the objectives drive the creation of content of the overall learning process.

State-dependent learning is an important factor because it recreates the learning environment, thus enhancing retention. Prior to the present invention, state-dependent learning has been largely ignored in post training regimens. State-dependent learning recreates the state a student was in during an initial learning experience, relying on the fact that the mind (emotional) and body (physical) state one is in when undergoing a learning experience is stored in the mind along with the learned information. When the congruent emotional and physical state environment is re-created by the facilitator during a follow up session and re-experienced by the student, the student may also re-experience the event training learning when the memories of the emotional and physical stimulae experienced at the time of the original learning arise. State-dependent learning happens when the recall of learned information is enhanced if the student is in the same sensory situation and physiological state as he/she was in during the original learning experience. During learning, a student will process the information to be learned, and will also associate this information with different internal and external experienced cues. Recreation of these cues provides enhanced factual recall using reproduction memory versus false factual recall which happens when the information is reconstructed. The present process allows the opportunity to correct any false memories from reconstruction with the weekly conferences utilizing reproductive learning.

The recreation of the physical/emotional state is an important component of memory. Therefore, a follow up conference program using the appropriate visual, auditory and kinesthetic techniques addresses both learning and retention needs. Most learning lacks follow up in general. In the few instances where some sort of follow up is included after event training, it generally is not designed to be applied to real world settings. Moreover, state-dependent learning is not even considered. Therefore, the present invention fills the learning and retention gap created by event training alone, and other follow up methodologies.

Since the true goal of any instruction is for the student/trainee to gain mastery over the material with enough recall and retention to utilize the new knowledge or skill over time, then simply attending event training, for whatever the duration, is not sufficient to gain the requisite mastery. The benefits of event training are usually short-term if not followed up with real world application. Most event training, by virtue of its finite time and location constraints, can only include simulations of the application of knowledge to real world situations. Therefore, practical exercises in the student/trainee's daily education, such as on the job or daily activities, or interacting with friends, relatives, acquaintances, newly met individuals or the like is virtually non-existent. The key to achieving a requisite competency level is continuing to expose the student/trainee to the ideas over time in addition to daily execution, utilizing techniques addressing all three learning styles, i.e., visual, auditory and kinesthetic. The old adage, “Practice makes perfect” is especially apt here.

Certain educational courses have developed follow up procedures to be applied after the event training in an effort to reinforce the event training information in the psyches of the students. These known follow up procedures design the training steps, develop content prior to the actual conduct of the follow up sessions, resulting in a linear, inflexible, constraining and mostly time-consuming follow up pedagogy. For example, in such previous follow up sessions, the student remains in the classroom, and the learning reinforcement is directed to the pre-created materials taught to the student during the event training. The follow up session does not include comments from students on how they applied the information to their daily activities, feedback from other students in a group environment on their experiences in actual practice of the event training information, nor modifications of each follow up session based upon the students' comments stated at a prior group environment follow up session based on their experiences in applying the event training information to everyday life activities, including positive, negative and/or neutral experiences.

In each such prior follow up procedure, learning is primarily separated from the daily activities and experiences of the student. Additionally, these prior procedures do not discuss all of the following: (1) event training information, (2) results in a conference session, (3) each student obtains feedback on their experiences, good and bad, from other students, and (4) suggested guidance from a trained facilitator. For example, certain extant training follow up procedures are conducted by an internal company-furnished leader, with no education credentials, such as a sales manager rather than a professionally trained facilitator.

A primary problem in prior follow up information training procedures is that the content of the follow up material to which the student is exposed is prepared solely prior to the commencement of the follow up program, and is based upon the students reading or listening to pre-written, literature based materials that do not take into consideration the students' experience in applying the information in their daily activities. This provides the students with only broad, pre-conceived action guides that may not have any application to the actual experiences of the students in applying the event training information in their daily activities. Students in prior follow up courses are also advised to eliminate all negative experiences from the follow up discussion, thereby depriving each student from benefiting from their mistakes through feedback received from a facilitator and/or other students.

Additionally, goals that the students should aim towards are established in prior follow up programs ahead of the event training sessions, or ahead of the commencement of the follow up conferences. There is no customized personal and/or organizational goal setting protocol in these prior programs that is based upon a student's actual experiences putting the event training to use, nor upon feedback generated at a follow up session. As a result, the follow up conference sessions of the prior art do not vary, nor take into account the learning curve of the student as the student gains knowledge and confidence through use of the event training information, and feedback from others when such experiences are the subject of open discussion and feedback. Also, since such feedback is not found in the prior training programs, these programs do not provide accountability to ensure that each student's goals are satisfied, or at least are on track towards being met, and there is likewise no accountability for individual commitment in such prior programs.

In prior training programs, the adherence to pre-planned directions and requiring responses to preconceived questions, without self direction and the ability of the student to apply the event training information to the actual daily scenarios and receive feedback on these experiences, limits the amount of active, retentive learning the student receives in the follow up sessions. It has been determined that follow up learning programs that are tied to preconceived book content and other materials cannot provide the proper level of information retention required by the providers and sponsors of training programs.

### SUMMARY OF THE INVENTION

A solution to the problem of how to increase information retention and improve mastery of the materials presented during the course of any event training has been developed. The method includes repeated exposure of the ideas presented during the event training over the course of a minimum number of periodically presented follow up conference sessions, from one session on up, each of a predetermined length, depending upon the event training content. These periodic sessions can be facilitated in person, over the internet, or most often, via conference calls. The conference call is a cost effective way to bring the event training attendees back together again without the cost of travel expenses or time away from their daily normal or daily work activities. The participants are provided via the inventive method with a “wise, loyal advisor” to improve the learning curve, while the participants are still able to conduct, fulfill and enhance their daily work activities.

Upon completion of the event training in an embodiment of the present invention, the attendees will spend approximately one hour per week, more or less, on the conference call directed and conducted by a facilitator. During these approximately one hour sessions, the knowledge and information imparted to each attendee during the event training will be reinforced. To prepare for full participation during the conference calls, the attendees are required to complete assignments by certain deadlines, usually prior to the conference session. These assignments may be administered orally by the facilitator during the conference call, and/or the facilitator will direct the attendees to an online website, where these assignments will also be available. The assignments can also be delivered to the attendees via other known communication means, such as email, internet, telephone, fax, mail, or the like.

If a website is utilized, it is preferably accessed via protected individual identification names and passwords. Certain of the assignments can be completed online. This will assist the facilitator in determining whether the attendees have been practicing and applying the event training principles to their daily environment. The completion of online assignments also allows the facilitator to monitor each attendee's competency level in real time with the assigned materials. In addition, many assignments can only be completed by practicing tasks that put into actual practice during the course of the attendee's routine day the learning objective information imparted at the event training. For example, if sales skills were the subject of the event training, then the homework assignments would require practice of a concept or technique with actual customers during sales calls the attendee would routinely be conducting during the normal work day. It is anticipated that the conference session will include comments from each student on experiences gained from actual practice of the tasks, as well as an evaluation of the retention of the learning objective information by each student when performing such tasks as a result of comments by the facilitator as well as other students.

In one embodiment, the website also enhances the facilitator's ability to communicate each attendee's mastery of the material to relevant parties, such as the attendee's employer or manager. The mastery will be determined not only by the completeness of the assignments by the deadline, but by their accuracy. A cumulative point system will be in effect with the participant earning the highest cumulative points receiving a Total Points Reward. This Total Points Reward will be announced at the final session of the several conferences.

The attendees participating in the periodic sessions of the follow up program will be given a further incentive to participate fully during the follow up conference, because each participant will be asked to vote for the participant in the conference that contributed the most in terms of real world application experience sharing, skill innovation, etc. This vote will be registered online at the website, and in the event of a tie, the facilitator will break the tie. The attendee who is deemed to have contributed the most by vote of his/her fellow participants will win the MVP Reward for the conference session, and can choose a periodic gift item.

The participant's employer or manager(s) may also elect to determine another reward based on the company's or department/division's own internal competition which can be tied into the follow up program. This could include an increase in sales, or some other appropriate measure, dependent upon the behavior change expected by the reinforcement of the event training materials.

In an embodiment of the present invention, the content of each follow up conference session is prepared and/or modified prior to each conference session, and after each student has submitted information as to the results of their previously assigned tasks. Thus, the content of each follow up conference session is customized predicated upon student feedback.

An object of the present invention is to assist the student/trainee in achieving the type of successful learning retention provided by repetition and actual practice of educational elements.

A further object of the present invention is to assist the student/trainee to successfully transfer knowledge acquired during an event training classroom session into actual implementation in the workplace, or while accomplishing work activities.

Another object of the present invention is to provide students of an event training course of education a follow up process that compels the students to apply the learning and skills acquired in the classroom to “real world” situations at home and at work, allowing each student to develop a better understanding of the principles imparted during the event training through the use of feedback from a course facilitator and from fellow students in a conference environment.

Still another object of the present invention is to provide a follow up process for students of an event training program that allows the students to share their successes, difficulties and failures during a series of follow up conference sessions, providing a more lasting and enjoyable learning experience.

A further object of the present inventive process is to maximize the contribution of each student taking part in the follow up conferences by presenting periodic awards to a student selected by the students themselves. For example, a Most Valuable Player (MVP) Award could be given to the student who contributed the most to the group conference discussion through the utilization of the assigned tools and techniques. Another example is to have the management of the students' employers provide rewards for a) sales dollar increases by the students, b) number of MVP votes received, c) and/or outstanding contribution to work on written or online assignments, and/or group discussions.

The learning follow up process of the present invention incorporates all three different learning styles:

1) Auditory

The auditory learner tends to thrive in a traditional training format. Many trainers utilize the “lecture” technique, exposing participants to content by speaking in front of the learners. The instructor can maintain the interest and attention of the participants by modulating content, voice tone, inflection, and body language. The key to training an auditory learner is to read directions aloud and present speeches or information requests verbally. The process of the present invention addresses the auditory learner through the use of conference calls or conference sessions where participants discuss the content under the direction of a trained facilitator.

2) Visual

The visual learner tends to thrive when provided diagrams, charts, pictures, films, and written directions. The instructor can maintain interest by providing to-do lists, assignment logs, and written notes. The process of the present invention addresses the visual learner through the use of visual materials including reading assignments, quizzes, and short essay questions, delivered in written format, online or in person.

3) Kinesthetic

The kinesthetic learner tends to thrive when actively engaged in a learning activity. This type of learner absorbs content quickly when participating in a science lab, drama presentation, skit, field trip, dance, or other practice activity. Conventional wisdom holds that there are a higher number of kinesthetic learners compared to visual and auditory learners. This requires a more hands-on approach to training in the workplace. Most learners excel through kinesthetic means: touching, feeling, and experiencing the material at hand. The process of the present invention addresses the kinesthetic learner by application of the learning objective content directly to the work environment. Students are required to “practice” the principles they learned during event training and discuss their experiences during the conference call or conference session.

The above objects and procedures are implemented in the present invention, which provides a method of enhancing the retention of learning objective information imparted to a student during an event training program led by an instructor. The method includes performing assigned activities by the student following the event training, which activities include tasks putting into actual practice in the student's daily activities, the learning objective information imparted to the student during the event training program. The student participates in one or more follow up conference sessions during which sessions the learning objective information imparted to the student during the event training is reinforced through predetermined discussion conducted by a follow up program facilitator. The preparation of content material for each follow up session is predicated upon and includes the original content of the instructor led event training, along with information gathered from each student prior to each follow up session, such information including the culmination of student experiences in learning the content in performing the assigned activities. The discussion at the follow up conference includes comments from the student on experiences gained from actual practice of the tasks. The retention of learning objective information by a student after an event training program is evaluated, the evaluation including an assessment of assignments completed by the student and by the student's participation in the discussion.

### DETAILED DESCRIPTION OF AN EMBODIMENT OF THE INVENTION

The follow up session model of the present invention is specifically tied to a student's actual work and life experiences in using the knowledge imparted at an event training, discussing positive, negative and neutral experiences with other students and usually a facilitator, thereby obtaining feedback regarding those experiences leading to learning and behavioral changes.

In accordance with an embodiment of the present invention, the training model of the follow up sessions are holistically designed and tailored to correspond to and enhance the student's retention of the information of the information imparted at the event training, including, if desired, the incorporation of objectives specific to the desires of the presenter or sponsor of the event training. By adhering to the steps of the present invention, each follow up session in a given program is different, and takes into account, by appropriate modifications of the session content, the progress of each student in applying the information while the student performs daily activities, and by the student obtaining feedback from other students and a facilitator.

In an embodiment of the present invention, the design and preparation of the content of each follow up conference session is completed prior to each conference session, and after each student has provided information regarding their previously assigned performance results. The modules of training in the follow up conference session are predicated on and modified in accordance with student feedback based on the student's actual experiences in applying tasks learned in event training sessions to everyday job performances. The content also incorporates the student's perception of performing the tasks with absolute success. As a result, the follow up conference sessions are continually customized based on student feedback. In this way, each follow up session directs the training to the specific needs and schedule of each individual student, resulting in individualized training emanating from a group conference setting.

In comparison to standard literature-based educational sessions, such as the event training preceding the follow up conferences, the students in the follow up session respond to non-literature based, provocative, goal oriented questions. These questions are based on the student engaging in actual performance of specific scenarios and case studies, actual performance during everyday experiences such as on the job experiences, and working through the solutions to specific, identifiable problems. The goals are set periodically to focus on objectives to be met by the student, based on the student's experiences plus feedback generated at the follow up session. Thus, the process of establishing goals has a built in flexibility.

The present inventive process also provides accountability to ensure that individual student goals are achieved. The follow up conferences ensure that each student is oriented to, and is individually responsible for, meeting their own established goals. This results in self-directed use of the event training information and knowledge in the practical, everyday job experiences of the students. The students proceed to learn at their own pace, and provide their own push to their progress.

Compared to previous follow up educational techniques, where students adhere to pre-planned directions, students engaged in the present follow up conference program are engaged fully in an active learning process. The framework for this active learning process is created and monitored by the facilitator and includes self-directed activities by the participants. The students solve their own problems, provide input into the problems of other students, formulate questions of their own, and discuss answers to these questions based on actual experiences. The students also discuss, explain, debate and/or brainstorm the event training information and its practical applications in a team setting. This results in positive interdependence among students, the ability to gain knowledge through the positive and negative experiences of others, and provide accountability for their activities to the group and to themselves.

Knowledge obtained at the event training may provide the students with short term mastery of the subject skills. However, the present inventive follow up conference process provides each student with long term retention and depth of understanding of the event training information through a) applying the information to actual relevant experiences, b) commenting in the follow up sessions about the positive and negative experiences of themselves and other students, and c) obtaining direct feedback and constructive criticism from other students taking part in the follow up session. These steps also lead to the acquisition of critical thinking abilities to be applied to creative problem solving. The formation of a positive attitude towards the event training information is developed in each student, resulting in increased levels of confidence in the imported knowledge and skills.

The follow up conference also provides the student with the ability to visualize the “perfect” performance of a related learned activity in full confidence and mastery, compared to their “non-perfect” actual performance of the event training information prior to the follow up session. In the follow up conference, the students may be encouraged to describe this “perfect” visualization in an essay, taking advantage of the fact that the act of writing recreates the scenario in the mind, thereby adding affirmation.

Prior to the Event Training

The success of the follow up, or reinforcement program begins prior to the actual event training itself. The weekly follow up conference materials must be initially planned and developed utilizing the educational or learning objective content imparted during the event training. In addition, the assignments and materials must be created utilizing the event training content as a basis. It is contemplated that all assignments utilized both during the conference sessions and in the website online materials, when utilized, must be customized and tailored to reinforce the learning and retention of the particular content of the event training. The entire substance of the event training must be broken down into a manageable number of follow up sessions so that the reinforcement each week will cover the correct amount of material. Too much information during one session could overwhelm the participants. Also, as will be discussed, the initial content of each follow up conference will be modified in accordance with a student's performance in completing the assignments prior to a given conference.

The follow up conference sessions will include use of group discussion questions based on practicing the skills, techniques and concepts covered during the event training. The follow up conference sessions will also include reinforcement of the main points covered during the event training specific to that session.

The assignments prepared prior to the follow up conferences could include the use of essay, multiple choice, short answer and/or fill in the blank questions, along with visualization techniques and any additional substantive materials used to re-emphasize the main points of the event training. Completing job tasks will also be required assignments, as explained further. Moreover, the follow up program participants will be directed to practice the skills, techniques and concepts during the normal course of their daily activities with clients, customers, co-workers, family and friends.

Prior to the event training, the facilitator preferably will have an in-person meeting or conference call session with each student's employer and/or manager(s) to ensure that all parties understand the benefits, the process, the goals, the rewards, and confirm the logistics for the follow up program.

During the Event Training

In the event that the follow up program facilitator is not the event trainer, the follow up program facilitator must be present at the event training. The purpose of attending the event training is so that trust, credibility and rapport can be created with the participants, and to allow the follow up program facilitator to grasp the content of the event training. Even though another event trainer might be leading the event training, the trainees need to know that the follow up program facilitator is committed to the trainees' success, understands the issues and materials, and is as competent as the event trainer.

The follow up program facilitator will be required to assist during in-class exercises, answer questions both during the class and during breaks, and provide coaching to the attendees as required during the event training.

Moreover, the follow up program facilitator is expected to observe and note the subtleties, nuances, and inside jokes occurring at the event training, and be prepared to reinforce this information during the follow up program. For example, if either the event trainer or an attendee related an anecdote that significantly furthered the comprehension of a specific idea or technique, then the follow up program facilitator should refer to that particular anecdote during the follow up program to reinforce the comprehension of that point.

At the end of the event training, as the event training is wrapping up, the follow up program facilitator introduces the follow up program to the students. The introduction includes a discussion of the benefits of the follow up program, as well as what will be required of the participants via the online exercises and the practice-at-work assignments. The deadline schedule for completing the online assignments will also be discussed. The date and time of the first scheduled follow up conference session will be confirmed.

Additional logistical information must also be disseminated at this time. The logistical information could include the toll free telephone number and password to use to join the conference call session, the website address, and/or the personal identification name and password needed to access the online assignments. Fax numbers, in the event faxes are used for assignment transmission and submission, could also be disseminated.

The follow up program facilitator will also complete a roster of the participants of the follow up program with the appropriate contact information, including name, title, division or department, manager's name and contact information, address, telephone numbers (work, cell, home), e-mail address (es), fax number(s) and the like.

Prior to the Conference Sessions

For maximum impact, the first conference session should be facilitated within two weeks of attending the event training. This time may vary under varying circumstances.

The follow up program facilitator will read and review the conference outline and the completed online assignments in preparation for each conference session.

The follow up program facilitator will be responsible for checking the completeness of the online assignments prior to each conference session. If a participant is struggling with the material, the follow up program facilitator, at his/her option, can choose to e-mail, telephone or fax the participant to offer guidance, mentoring and/or advice. The follow up program facilitator may also choose to bring the troubling issue up with the group of participants during the follow up conference session if more than one participant is struggling with the same concept or educational point.

Prior to the conference sessions, the follow up program facilitator prepares a conference follow up program outline to be used as a guide during the conference sessions. As explained, the content of each follow up conference session is modified in accordance with student performance in their assignment tasks, including the culmination of student experiences in learning the content. Set forth below is an exemplary outline for a plurality of follow up sessions.

The conference sessions outline serves as a template for the facilitator to modify as needed, based on the participant's contributions as well as the original learning content. This shared learning dynamic will create a state dependent environment that enhances long term retention of original learning content and objectives.

First Conference Session

I. Greet Participating Students
   A. Take Attendance
   B. Ask one or two Group Discussion Questions relating to experiences and learning achieved since attending the Event Training.
   C. Get Responses from Participants.
   D. Create a Positive Atmosphere Conducive to Learning.
II. Explain Conference Format
   A. Explain the Learning Objectives and Benefits of the Conference Series.
   B. Explain the Weekly Award(s)
III. Introduce The Weekly Segment of the Event Training Content to be focused upon.
   A. Discuss the Benefits of reinforcing the Event Training Content covered in the Conference Session.
   B. Summarize Event Training Content.
   C. Ask Group Discussion Questions reinforcing the Event Training Content.
   D. Obtain Responses from Participants.
   E. Create a Positive Atmosphere Conducive to Learning.
IV. Goal Setting
   A. Introduce Personal Goal Setting to elicit Participant Commitment to Activities.
   B. Have Participants Publicly Share their Goals/Commitments.
V. Review Assignments to be completed before the next Conference.
   A. Provide overview of the next Conference's Content.
   B. Explain assignments.
VI. Conclude the Conference
   A. Thank Participants.
   B. Recap specific contributions and learning.
   C. Remind Participants of next Conference date and time.
   D. Remind Participants to Vote for the Weekly Award Winner.
   E. Encourage Participants' Commitment to Personal Goals.
VII. Handle Post-Conference Logistics.
   A. Tally votes for Weekly Award Winner.
   B. Handle any administrative issues.
   C. Review Participant's completed pre-work assignments prior to the next Conference.
      Second Conference Session on, but excluding the Final Conference Session
I. Begin the Conference
   A. Greet Participants.
   B. Take Attendance.
   C. Announce and Congratulate Weekly Award Winner(s).
   D. Explain the Benefits of the Event Training Content to be covered during this Conference Session.
   E. Ask preliminary Group Discussion Question(s) relating to experiences and learning achieved since last week's Conference Session.
   F. Get several responses from Participants.
   G. Validate experiences and learning.
II. Introduce the Weekly Segment of the Event Training Content to be Focused Upon.
   A. Discuss the Benefits of reinforcing the Event Training Content covered in the Conference Session.
   B. Summarize Event Training Content.
   C. Ask Group Discussion Questions reinforcing the Event Training Content.
   D. Get Responses from Participants.
   E. Create a Positive Atmosphere Conducive to Learning.
III. Review Assignments to be completed before the next Conference.
   A. Provide overview of the next Conference's Content.
   B. Explain assignments.
   C. For the Conference Session immediately prior to last session only, Introduce guidelines for the Speech each Participant is required to give during the Last Conference Session.
IV. Conclude the Conference Session
   A. Thank Participants.
   B. Recap specific contributions and learning.
   C. Remind Participants of next Conference date and time.
   D. Remind Participants to Vote for the Weekly Award Winner.
   E. Encourage Participants' Commitment to Personal Goals.
V. Handle Post-Conference Logistics.
   A. Tally votes for Weekly Award Winner.
   B. Handle any administrative issues.
   C. Review Participant's completed pre-work assignments prior to the next Conference.
      Last Conference Session
I. Begin the Conference Session
   A. Greet Participants.
   B. Take Attendance.
   C. Announce and Congratulate Weekly Award Winner(s).
   D. Explain the Benefits of the Event Training Content to be covered during this Last Conference Session.
   E. Ask preliminary Group Discussion questions relating to experiences and learning achieved since the prior week's Conference Session.
   F. Get several responses from Participants.
   G. Validate experiences and learning.
II. Introduce the Weekly Segment of the Event Training Content to be focused upon.
   A. Discuss the Benefits of reinforcing the Event Training Content covered in the Conference Session.
   B. Summarize Event Training Content.
   C. Ask Group Discussion Questions reinforcing the Event Training Content.
   D. Obtain Responses from Participants.
   E. Create a Positive Atmosphere Conducive to Learning.
III. Conclude the Conference Series
   A. Thank Participants for their full engagement in the Conference Series.
   B. Recap the Learning Objectives and Benefits of the Conference Series.
   C. Participant Speeches.
   D. Congratulate each Participant on their individual and collective accomplishments.
   E. Announce and Congratulate the Cumulative Award Winner.
   F. Facilitator's Concluding Remarks.
      Assignments
I. All assignments to be completed before each Conference Session should include a combination of the following types of activities consistent with the Event Training Content.
   A. Multiple choice questions.
   B. Short Answer
   C. Essay
   D. Empowering Language—Affirmations
   E. Visualization and Essay
      i. Visualize doing the Event Training Learning Activity very successfully. Detail the visual, auditory, kinesthetic, emotional, psychological feelings and sensations of mastery.
      ii. Visualize doing any activity with extreme competence and confidence. In recounting this past success, the participant analyzes and documents his/her winning formula and then is instructed to apply the same physical/emotional winning formula state to the Event Training Learning Activity.

### Tasks and Assignments Prior to Each Conference Session

Prior to the first follow up conference session, and prior to each subsequent follow up conference session, the students are given an assignment that requires them to put into practice in their daily jobs or work experiences, or with their friends and/or family, behaviors, procedures, etc. of the learning objective information imparted during the corresponding event training session. These tasks are customized to reinforce the specific learning objective information imparted to the student during event training. For example, if the event training session covered techniques used to introduce the student and his/her products/services during an initial sales call on a customer, the assignment will be to use these techniques during the actual daily sales job activities of the student, and to note successes, failures and possible modifications to these techniques. The assignment will also ask each student to set goals for their performance in carrying out the tasks comprising each daily job assignment, and to note the attainment, or lack thereof, in meeting these goals. The student's success or failures in meeting these goals will be discussed during a subsequent follow up conference session.

In an embodiment, the students are required to submit their assignment answers prior to the subsequent follow up conference session. The facilitator reviews the responses, and modifies the content of the subsequent follow up conference session to incorporate issues raised by the assignment answers into the discussion at the next session. In one embodiment, the students are required to report on the results of their tasks using the learning objective information in their daily job activities in a series of staggered deadlines. This ensures that the student retains the learning objective information over a period during which such tasks are performed during accomplishment of the student's daily activities.

Additional assignments include responding to questions posed to the students by the facilitator relating to the corresponding event training, and/or to the goals established by the students. Such assignments may be delivered electronically to the students, for example via internet delivery, machine readable disc, or any other known electronic data delivery system known in the art at the time of use of the present inventive process. Such questions can be multiple choice, essay, short answer or fill in the blank questions. Other assignments could include visualization and/or the use of empowering language or affirmation. The students' answers to these questions will be discussed at the ensuing follow up conference.

During the Conference Sessions

During each conference session, the follow up program facilitator takes attendance of all participants on the conference call, in order to monitor any adverse issues with participation.

The follow up program facilitator follows the conference program outline as prepared prior to the conference, and as modified in accordance with student assignment responses, to properly cover the material and remain on time.

The enthusiasm of the follow up program facilitator is a key factor in the success of the conference follow up program. The follow up program facilitator should convey compliments to the participants when warranted, and mention the participants' strengths often, especially when the students are struggling with a concept. Thank the participants, and recap specific contributions and learning often.

The follow up program facilitator guides the discussion during the conference in a non-threatening environment. The follow up program facilitator's role is to listen and encourage.

The follow up program facilitator needs to ensure that each participant speaks during each session. The follow up program facilitator also needs to maintain an efficient pace in order to stay within the predetermined timeframe, and the facilitator should be an example of modeling the event training behavior participants aspire to.

The student participants' actual practice of the information gained during the event training will result in developing high motivation as they experience weekly mastery. The participants will already have applied many of the concepts immediately after the event training. The sharing of both successes and difficulties makes the group conference discussions very rewarding.

In an embodiment, during the conference session, the students will respond to unstructured open-ended questions in an attempt to solicit responses from the student explaining what occurred when the student applied the learning objective information imparted at the event training during the daily activities of the student. By performing the task-based assignment activities, and discussing favorable, and unfavorable, results with the facilitator and with other students during the conference session, the specific learning objectives of the event training session are reinforced in the student's memory.

During the conference session under the direction of the facilitator, the students also openly discuss the goals each student established for him/herself prior to and to be focused upon when performing the task-based assignments during their daily activities. This procedure provides the student with a sense of accountability for his/her performance of the assigned tasks completed prior to the conference session, and for meeting his/her self-established goals.

The facilitator and the students all take an active and energetic part in each conference session. One of the facilitator's tasks is to assist the students in the problem solving process by directing students in the appropriate direction leading to the solution of difficult principles encountered in performing the learning objective steps during the students' daily performance. The cross-discussion between the students and the facilitator allows each student to assist other students, through a discussion of their varying experiences, in the reinforcement of the learning objective information. The facilitator will direct each student, during the conference session, to discuss the benefits and difficulties of, and the resulting successes and failures in, applying the learning objective information to the daily activities of the students.

Another major advantage provided by the conference session procedure described above is that during the conference session, the comments of each student relating their practical experiences in using, or attempting to use, the learning objective information support the ability of other struggling students to improve their performance by offering examples of successes in applying the learning objective information in actual, practical situations.

Re-emphasizing the main points of learning from the event training will be conducted during each conference session to improve retention of information. During each session, the follow up program facilitator will remind participants of their next conference session date and time. The follow up program facilitator will also remind each participant to vote for an MVP Reward Winner online, or by other means, immediately after each session is completed. The follow up program facilitator is required to encourage the participants to stay committed to their goals by keeping their activity level high at each conference session.

During the last half of the final conference session, each participant is required to give a two minute presentation about everything he/she learned through participating in the follow up program, completing the assignments, and practicing the tools and techniques every week. Each participant will also be asked to memorialize his/her thoughts in writing or electronically, and also to share those thoughts with the other participants. The participants will be reminded that the two minute presentation should include the following:
1. The major benefits he/she received by participating in the follow up program.
2. The impact he/she feels this learning will have on his/her future success.
3. Comments on how his/her perception of how his/her own abilities have changed as a result of this follow up program.
4. Comments on how his/her confidence in his/her own skills has improved as a result of participating in this follow up program.
5. The most important success he/she achieved as a result of utilizing the reinforcing learning techniques gained through the follow up program.
6. The success in achieving his/her personal goals, which personal goals the participant shared with the other participants during the first week of the follow up program.

The present invention enhances the student's ability to learn through the process of state-dependent learning. One of the ways the present invention creates the same emotional and physical state in the student is the follow up session facilitator attends the event training, and takes notes of the student's interactions with and reactions to the event training content. When preparing the follow up sessions, the facilitator incorporates these reactions and interactions to customize the content of the follow up session, such that the content is customized to reinforce the material learned at the event training through the weekly regular activities of the student. This procedure places the student's focus on memory based retrieval of information.

Another way the present invention creates a congruent emotional and physical state in the student is that during the follow up conference sessions, the students will be asked to share their experiences in performing the assignments in their real life activities. While sharing, students will be guided by the facilitator to recall not only the visual, auditory and kinesthetic sensory activities they experienced, but also the emotional/psychological states they experienced while performing the assignments in real life settings. The emotions of the learning state will be created both personally (through recalling and verbalizing with other participants) and also vicariously (as a result of listening to the input of other participants).

Between follow up conference sessions, the students apply the event training learning to their every day activities. In addition, the students are asked to visualize themselves performing the event training learning activity, seeing themselves performing very successfully, with total mastery and confidence. The students are also asked to describe this visualization in an essay format, which recreates the learning activity in the mind of the student.

The visualization and essay format will include specific instructions for describing in detail the physical and emotional sensations associated with success.

A further way to recreate the emotional aspect of the learning state in the follow up conference session involves having the student visualize and then document in essay format the circumstances when the student was successful in performing any activity. In recounting and expressing this success, the student is asked to detail and analyze those physical and psychological factors that contributed to his/her success. Through this analysis, the student is able to determine and document his/her own successful formula, which formula can then be applied to the event training learning activity.

After the Conference Session

The follow up program facilitator tallies the votes for MVP Reward Winner after each conference session. The winner of the previous session is announced at the beginning of each subsequent conference session. The facilitator also maintains a running tally of the cumulative points earned by each participant in order to award a Total Points Reward to be announced during the last session. If the company sponsor or program sponsor has opted for an additional reward, the follow up program facilitator receives the appropriate statistics from company or sponsor management.

The follow up program facilitator then notifies administrative support of who the MVP Reward winner(s) are so that the appropriate prizes may be sent to the winner(s).

Training Evaluation

In 1994, Donald Kirkpatrick developed a model consisting of four levels of evaluation of training. A simple definition is as follows:

Level 1—“Did they like it?”

Level 2—“Did they learn it?”

Level 3—“Did they use it?”

Level 4—“Did it matter?”

Most extant training evaluation measures the reaction to Level 1 with short evaluations, or “smile sheets” at the end of event training classes. Prior to the present invention, most training was not evaluated past this level. The present invention provides a model for follow up reinforcement to traditional training programs that supports the measurement of learning, transfer and results while assisting participants with the transfer of knowledge to their everyday work endeavors.

Level 2 of the Kirkpatrick model goes beyond the student's basic satisfaction with the event training, and moves into assessing the student's improvement in skills, knowledge and/or attitude. A further stage of an embodiment of the presently described method consists of students being administered a test or pre-assessment before the event training, as well as after the post-assessment materials and assignments of the event training have been completed. This determines the amount of learning that has occurred during the event training. The present follow up process is designed to begin within approximately two weeks of the conclusion of event training. The assignments that enable the Level 2 evaluations are included as assignments administered either on line or by some other convenient known manner.

A Level 3 evaluation determines if the newly acquired skills, knowledge and/or attitude of the student are being applied in the real-world environment of the student. Many trainers consider this level to be the best estimate of a program's efficacy. Due to the wide variance in learning curves between most students, this level can be difficult to measure. However, the present novel process requires participants to apply the course objectives to their daily work environment, which in turn reinforces the principals taught in the event training sessions.

The fourth level that is enabled by the process of the present invention measures the impact of the program on business initiatives such as production, quality, costs, safety, sales, profits, and/or return on investment. For many businesses and other organizations, these are the primary reasons to implement a training program, however these Level 4 results are not typically addressed in prior training follow up methods. The present invention can provide measurement of these qualities. To implement this element of the process, the business or organization with whom the student is associated provides sales, production, and/or other relevant data to the team administering the inventive process when a Level 3 evaluation is conducted in conjunction with an assessment of results.

The method of the present invention provides a supportive, encouraging environment to reinforce the precepts of any event training consistently over time. Retention by participants of not only the concepts, but also the skills and techniques imparted during event training will be significantly improved. With the appropriate number of conference sessions, the average being approximately eight sessions, each preceded by and followed by an online homework assignment, each participant is exposed to an idea a minimum of eight times over a spaced interval. In reality, each session is designed to reinforce a concept multiple times, with additional exposure occurring during the real life practice experience as well.

The above described method meets the true goal of any instruction by having the trainee gain mastery over the material with enough recall and retention to utilize the new knowledge or skill over time. The requisite competency level is achieved by continuing to expose the trainees to actual practice and discussion of the imparted knowledge over a spaced time interval.

We claim:

1. A method of enhancing the retention of learning objective information imparted to a student during an instructor led event training program, comprising the steps of:
a) performing assigned activities by the student following the event training, which activities include tasks putting into practice the learning objective information imparted to the student during the event training program;
b) participation by the student in at least one follow up conference session, during which follow up conference session the learning objective information is reinforced in the student through a discussion during the follow up conference session, which discussion includes comments from the student on experiences gained from actual practice of the assigned tasks;
c) the follow up conference session including content materials predicated upon the original content of the instructor led event training along with information gathered from the student prior to the follow up session, such information including the culmination of student experiences learning the content in performing the assigned activities.

2. The method of enhancing the retention of learning objective information of claim 1, including the step of evaluating the retention of the learning objective information by the student when performing the tasks after an event training program, the evaluation including an assessment of the student's participation in the discussion during the follow up conference session.

3. The method of enhancing the retention of learning objective information of claim 1 wherein the discussion during the follow up conference session is conducted by a follow up program facilitator.

4. The method of claim 2 wherein the step of participation by the student in at least one follow up conference session includes responding to unstructured, opened-ended questions designed to solicit responses from the student explaining what occurred in the application of the learning objective information during daily activities of the student.

5. The method of claim 1 wherein the assigned activities are delivered to the student via an electronic medium.

6. The method of claim 1 wherein the comments from the student are solicited using questions provided to the student in the form selected from the group consisting of multiple choice questions, essay questions, short answer questions and fill in the blank questions.

7. The method of claim 4 wherein the step of responding to questions requires the student to complete responses to the questions using a schedule of staggered deadlines, ensuring that the student retains the learning objective information during a period of use of the learning objective information during daily activities of the student.

8. The method of claim 1 wherein the discussion during the follow up conference session includes the step of having the student account for goals established by the student in performing the assigned activities.

9. The method of claim 3 including the step of the follow up program facilitator taking an active part in the conference session in assisting a problem solving process by directing the student to the solution of difficult principles.

10. The method of claim 1 wherein the step of performing assigned activities comprises the performance of tasks customized to reinforce the specific learning objective information imparted to the student during the event training.

11. The method of claim 1 wherein the step of performing assigned activities includes the further step of performing the tasks during the daily activities of the student.

12. The method of claim 1 wherein the steps of performing assigned activities and participation by the student in the conference session reinforces in the student the specific learning objective information imparted to the student during the event training program.

13. The method of claim 1 wherein the step of participation by the student in the conference session includes the additional step of the student establishing goals to be achieved prior to an ensuing conference session, the goals focused on tasks related to the specific learning objective information imparted to the student in the event training session.

14. The method of claim 3 wherein the discussion conducted by the follow up program facilitator is a structured discussion.

15. The method of claim 1 wherein the student is repeatedly exposed to the learning objective information during the at least one follow up conference session.

16. The method of claim 3, wherein the at least one follow up conference session is conducted by the follow up program facilitator in a personal meeting between the student and the facilitator.

17. The method of claim 3, wherein the at least one follow up conference session is conducted between the follow up program facilitator and the student via a communication conference selected from the group consisting of telephone conference, video conference and online conference, or any combination thereof.

18. The method of claim 17, wherein the communication conference is led by the follow up program facilitator and is participated in by a plurality of students.

19. The method of claim 1, wherein the student performs the assigned activities prior to an ensuing follow up conference session.

20. The method of claim 3, wherein the at least one assignment is administered orally by the facilitator.

21. The method of claim 1, wherein the assigned activities are made available to students on an online website.

22. The method of claim 21, wherein the comments by the student are completed and submitted by the students online over the internet.

23. The method of claim 3, including the step of the facilitator evaluating the student's comments to determine whether the student practiced and applied the event training program learning objective information to the student's activities related to the event training program.

24. The method of claim 2, wherein the step of evaluating the retention of learning objective information by the student includes monitoring the student's competency level with regard to the assigned activities.

25. The method of claim 1, wherein the learning objective information imparted to the student during the event training is reinforced during the at least one follow up conference session by repeated exposure of the student to the learning objective information.

26. A method of enhancing the retention of learning objective information imparted to a plurality of students during an event training program via at least one follow up conference session, comprising the steps of:
a) each student performing assigned activities after the event training, the assigned activities including tasks putting into practice and reinforcing the learning objective information imparted to the student during the event training program;
b) each student providing a follow up conference facilitator with information regarding the student's results in performing the assigned activities;
c) preparing materials for at least one follow up conference session, which materials include content based upon the information regarding the student's results in performing the assigned activities prior to the at least one follow up conference session, and
d) conducting the at least one follow up conference with the students in attendance.

27. The method of claim 26 wherein the step of preparing materials for the at least one follow up conference session includes preparing materials based upon the learning objective information imparted to the students during the event training program.

28. The method of claim 26 including the step of the follow up conference facilitator attending the event training program.

29. The method of claim 26 including the further step of advising the students about the existence of and procedures for each at least one follow up conference session.

30. The method of claim 26, wherein the follow up conference facilitator conducts each at least one follow up conference session, during which conference session the facilitator leads the students in a discussion of each student's experience in performing the assigned activities.

31. The method of claim 30, including the step of each student assisting other students in the reinforcement of the learning objective information during the at least one conference session by discussing the benefits and difficulties of applying the learning objective information to the daily activities of each student.

32. The method of claim 31, wherein the step of each student assisting other students in the reinforcement of the learning objective information during the at least one conference session includes discussions among the students of a student's successes and failures in applying the learning objective information to daily activities.

33. The method of claim 31, wherein during the at least one conference session, the discussion by each student supports other students through offering examples of successes in applying the learning objective information in the student's daily activities, which learning objective information other students were struggling with applying.

34. The method of claim 26, wherein prior to the at least one follow up conference session, the students perform the assigned activities while the students are engaged in the normal course of their daily activities.

35. The method of claim 28, wherein during the follow up program facilitator's attendance at the event training program, the facilitator records observations of student conduct in and reactions to the event training program.

36. The method of claim 26, wherein during the at least one follow up conference session, learning objective information from the event training program is re-emphasized to the students by the facilitator.

37. The method of claim 26, wherein the at least one follow up conference session is conducted via a conference procedure selected from the group of telephone conference, video conference, and on-line conference, or any combination thereof.

38. The method of claim 26, wherein the at least one follow up conference session comprises a plurality of follow up conference sessions.

39. The method of claim 38, wherein the final session of said plurality of follow up conference sessions includes a discussion by each student of the student's learning experience resulting from participation in the plurality of follow up conference sessions.

40. The method of claim 3 wherein the step of participation by the student in the at least one follow up conference session includes the step of holding a group discussion between the student and the facilitator of questions and topics relating to learning objective information imparted to the student during the corresponding event training.

41. The method of claim 1 wherein the step of participation by the student in the at least one follow up conference includes the step of obtaining student comments on those tasks the student performed differently as a result of the student's participation in the follow up conference session.

42. The method of claim 1 wherein the step of participation by the student in the at least one follow up conference includes a discussion of rewards awarded to the student based on performance of the student at a previous at least one follow up conference session.

43. The method of claim 1, wherein the step of participation by the student in the at least one follow up conference includes a discussion of tactical topics related to the event training developed through the student's performance of assigned activities.

44. The method of claim 3 wherein the step of participation by the student in the at least one follow up conference includes the step of discussing the student's goals as those goals are presented to the facilitator by the student.

45. The method of claim 1 wherein the step of participation by the student in the at least one follow up conference includes the step of discussing an assignment of tasks to be completed by the student prior to a subsequent follow up conference.

46. The method of claim 45, wherein the step of participation by the student in at least one follow up conference includes the step of the student discussing what the student discovered by completing the assigned activities prior to the at least one follow up conference.

47. The method of claim 1 wherein the step of participation by the student in the at least one follow up conference includes the step of concluding the at least one follow up conference with a discussion of significant learning points of the corresponding event training.

48. The method of claim 47 wherein the step of concluding the at least one follow up conference includes the step of discussing the student's contributions to the at least one follow up conference.

49. The method of claim 3 wherein the step of participation by the student in at least one follow up conference session includes the steps of:
a. holding a group discussion between the student and the facilitator of topics relating to learning objective information imparted to the student during the corresponding event training;
b. emphasizing to the student all subjects to be covered in the at least one follow up conference;
c. obtaining student comments on what the student is doing differently as a result of the student's participation in the at least one follow up conference session;
d. discussing rewards awarded to the student based on performance of the student at a previous at least one follow up conference session;
e. discussing tactical topics related to the event training developed through student assignments;
f. discussing student goals as presented to the facilitator by the student;
g. discussing an assignment to be completed by the student prior to a subsequent follow up conference;
h. having the student discuss what the student discovered by completing assignments prior to the at least one follow up conference; and
i. concluding the at least one follow up conference by discussing significant learning points of the related event training.

50. The method of claim 49, wherein the step of concluding the at least one follow up conference includes the additional step of discussing the student's contributions to the at least one follow up conference.

51. The method of claim 1 including the additional step of evaluating the effectiveness of the retention of learning objective information by the student by administering a first test to the student before the event training program and a second test after the event training program to determine the amount of learning gained by the student during the event training.

52. The method of claim 1 wherein the step of performing activities by the student is measured to determine the level at which the student has properly applied the learning objective information in actual practice when performing the assigned activities.

53. The method of claim 1 including the additional steps of obtaining data relating to the quality of performance of the student in performing the assigned activity tasks prior to the event training program, and comparing said data to the quality of performance of the student in performing the assigned activity tasks subsequent to the event training program.

54. The method of claim 52 wherein the step of comparing occurs after the at least one follow up conference session.
